(19) United States
(12) Patent Application Publication
(10) Pub. No.: US 2016/0150596 A1
(43) Pub. Date: May 26, 2016

(54) POWER SAVING INDUCTION COOKING PLATE, COOKING VESSEL AND INDUCTION COOKING ARRANGEMENT

(71) Applicant: ELECTROLUX APPLIANCES AKTIEBOLAG, Stockholm (SE)

(72) Inventors: Jennifer Burkhardt, Rothenburg ob der Tauber (DE); Michael Herzog, Rothenburg ob der Tauber (DE); Felix-Alexander Katz, Weil der Stadt (DE); Maike Meider, Rothenburg ob der Tauber (DE)

(73) Assignee: Electrolux Appliance Aktiebolag, Stockholm (SE)

(21) Appl. No.: 14/899,432

(22) PCT Filed: May 26, 2014
(86) PCT No.: PCT/EP2014/060817

§ 371 Date: Dec. 17, 2015

(30) Foreign Application Priority Data
Jul. 3, 2013 (EP) 13174884.0

(51) Int. Cl. H05B 6/06; H05B 6/12

(52) U.S. Cl. CPC H05B 6/062; H05B 6/1209

(57) ABSTRACT

The inventors of the instant invention have realized that blocking the thermal flow from a cooking vessel to the surface of the cooking area can provide power savings up to 4% according to energy measurements. According to embodiments of the invention, spacers (110, . . . , 120; 310, . . . , 370; 220; 410) are provided between the surface of a cooking area (105, 210, 380, . . . , 395) and a cooking vessel such as a cooking pot or a kettle. The spacers may be integrated in form of a curvature in a glass ceramic surface of a hob or may be placed at top of a cooking area (100). Another solution may be provided in the cooking vessel (400) such as a kettle that has an isolating lowest bottom in form of integrated spacers which can directly be placed on common induction hobs.

In modern households, cooking appliances in the form of electric ovens or gas ovens are almost present everywhere. In recent times, electric ovens are developing in the direction of induction powered cooking plates. This form of an electric heating mechanism has the advantage that it only heats the cooking vessel and thus has a low heat inertia.

Power consumption concerns also become more important in households as electric energy becomes more and more expensive. As a consequence, home appliance manufacturers strive to develop home appliances that consume less energy. In some countries, such as Germany, energy grades have been established in order to give a potential customer an indication about the energy efficiency of the device he is intending to buy.

In particular in the area of cooking devices, energy consumption is of predominant concern.

Induction powered cooking plates are per se known in the art. The page shown under the URL

“http://www.smalltao.com/product/18269636015/Electrical%20Tecworld%20TIANHE%20TH-A207%20Cooker%20generation%20product%20special%20radiation-free%20high-frequency%20stove”
shows an induction heater with wedges on the top. It appears that these wedges serve to position a cooking vessel. One of the pictures to be found for further illustration of the product show the text “hot after use, do not touch”. No other prior art is known.

The applicant has realized that at conventional induction heaters energy can be saved.

It is an object of the present invention to provide a power saving cooking plate, a cooking vessel and an induction cooking arrangement.

This object is solved by an induction cooking plate according to claim 1, an induction cooking vessel according to claim 13 and an induction cooking arrangement according to claim 15.

Advantageous embodiments are given in the dependent claims.

Advantageously, an induction cooking plate according to the present invention avoids that heat is transferred from a cooking good which is kept in a cooking vessel to a surface that supports an induction heating arrangement. In this manner, the thermal inertia is minimized and only the cooking vessel including the cooking goods is heated which minimizes the mass that needs to be heated and thus minimizes the power that is used for cooking.

Beneficially, in a further development of a cooking plate according to the instant invention, an isolated material is embedded in a cooking surface in order to disrupt the thermal energy flow back from the cooking vessel into the cooking surface. At the same time, advantageously, a flat cooking surface can be maintained that allows moving cooking pots back and forth without obstacles.

Favourably, according to a further development of an embodiment according to the present invention, spacers are provided to keep a cooking vessel in a distance to the inductive heater. In this manner, with a technically simple solution, the object of the invention can be solved and by using thermally isolating spacers, a maximum effect can be achieved.

Favourably, according to a further development of an embodiment of the instant invention, plural spacers are provided. In this manner, the cooking plate can be individually adapted to the size of the shape of a cooking vessel.

Beneficially, according to a further development of an embodiment of the present invention, the area occupied by the spacers is very small against the area of the cooking plate that usually conforms with the size of a cooking pot because in this manner, the thermal conduction back into the cooking surface can be minimized.

Beneficially, according to a further development of an embodiment of the instant invention, a cooking surface of a cooking plate has build-in spacers in a form of e.g. a protrusion. In this manner, an easy to clean monolithic surface is maintained while at the same time being able to benefit from the power savings provided by the present invention.

Favourably, according to a further development of an embodiment of the present invention, a curvature is provided in the cooking plate because curvatures are technically easy to manufacture, avoid steps in the surface and are easy to clean.

Particularly beneficial is a further development of an embodiment of the present invention where the curvature protrudes at least 10 mm from a flat surface of a cooking plate because it then provides an optimum distance between the cooking vessel and the flat cooking surface in order to maximally avoid thermal conduction while at the same time providing optimum inductive heating efficiency.

Beneficially, according to a further development of an embodiment of the present invention, a cooking plate comprises plural induction cooking areas. In this manner, the benefits of the instant invention can be provided for a household appliance and thus multiply the energy savings.

Favourably, according to a further development of an embodiment of the present invention, spacers extend over plural inductive areas. In this manner, beneficially, larger cooking vessels can be used and benefit from the advantages of the present invention.

Advantageously, according to a further development of an embodiment according to the present invention, the spacers are provided in form of bands that allow easy movement of a cooking vessel in the longitudinal direction of the bands.

Favourably, in a further development of an embodiment according to the present invention, isolation material is made of heat resistive material such as glass ceramic. In this manner, maximum disruption of a thermal energy flow can be achieved.

Advantageously, a cooking vessel according to an embodiment of the present invention has a bottom/spacer made of heat resistive material especially glass ceramic.

Advantageously, in this manner, a spacer is provided and integral with the cooking vessel. Such a cooking vessel also provides a maximum of ease of use for an operator.

Favourably, a cooking vessel according to an embodiment of the instant invention maybe respectively equipped with an isolation material of various shapes in order to be adapted to its daily use and to the technical requirements for such a cooking vessel, e.g. a cordless kettle.

Beneficially, a cooking arrangement according to an embodiment of the present invention comprises an induction cooking plate, a spacer made from thermally resistant material and a cooking plate. In this manner, a simple technical arrangement in form of different layers is provided that has the merits of the power saving according to the instant invention.

Further below, embodiments of the invention are discussed on a basis of examples shown in drawings wherein:

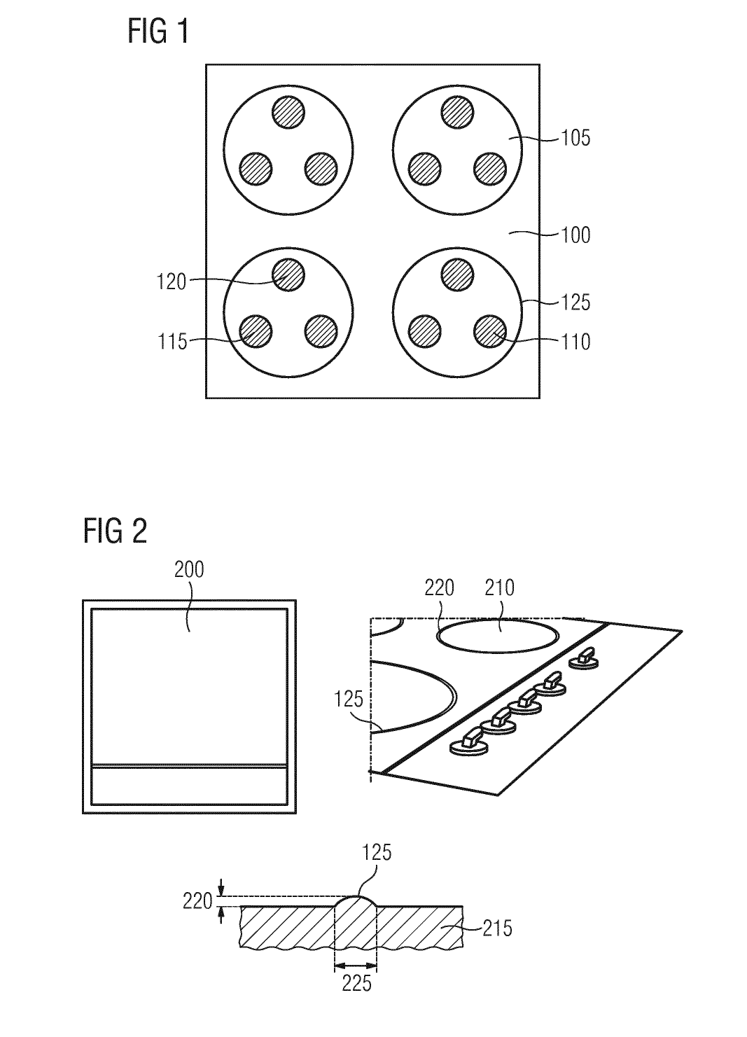

FIG. 1 shows a cooking plate;

FIG. 2 shows a section of an induction oven;

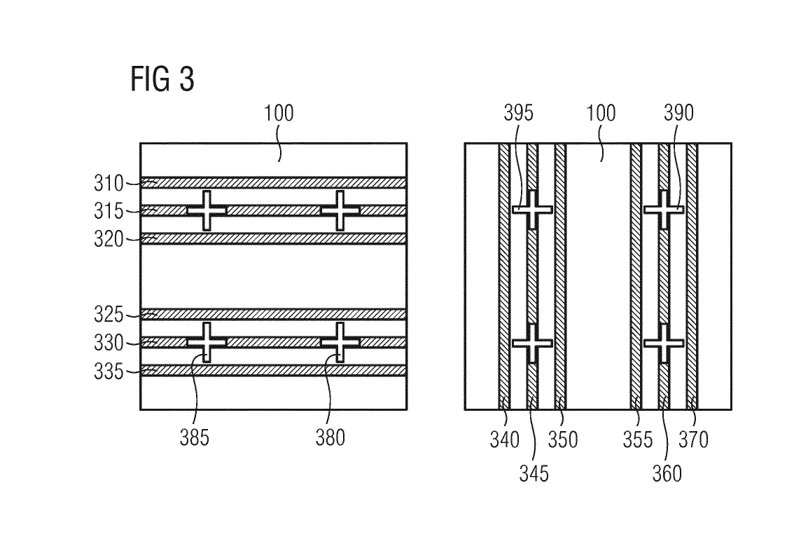

FIG. 3 shows two examples of a cooking surface having spacers;

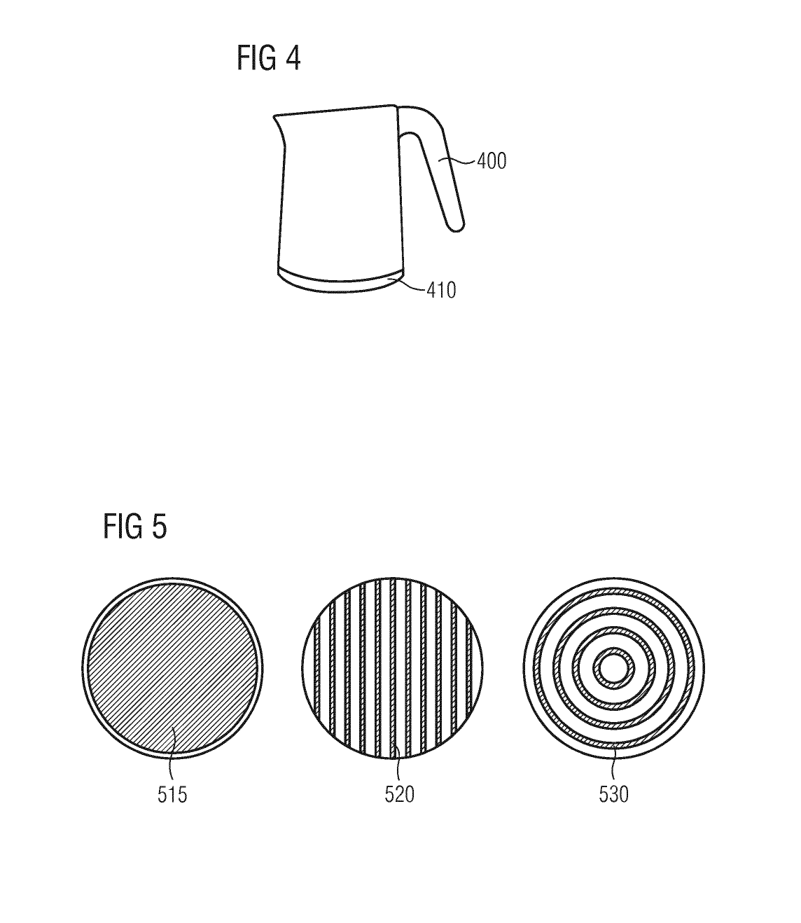

FIG. 4 shows a cooking vessel in the form of a cordless kettle; and

FIG. 5 shows different shapes of spacers at the bottom of the cooking vessel shown in FIG. 4.

As FIG. 1 shows, a cooking plate or hob 100 may consist of several individual induction cooking areas 125. In this example, each cooking area 125 is provided with spacers made from for example heat resistive material. The Applicant has found that spacers can save energy. The better the material prevents thermal conduction, the more efficient the cooking plate according to the present invention becomes. In this embodiment, spacers 110-120 are provided in the number of 3 having a circular shape. The shape of these spacers is only shown exemplarily and may take any other form that is suitable for the desired application. As long as the spacers allow the magnetic field from the induction heater to penetrate a metallic cooking vessel and prevent thermal energy to flow back into a cooking surface 105.

As FIG. 2 shows, an induction oven shown in the section 200 may be provided with separate cooking areas 210 having a border around them 125. In one embodiment, the cooking area 210 may be comprised of a layer of heat insulating material that is preferably made of thermally resistive material. In this manner, a totally flat surface of the hob can be provided that allows easy movement of pots from one cooking area to another. In one preferable embodiment, the border of the cooking area 210 may be formed of a curvature 125 that is 10 mm high and has a radius of preferably 2.5 mm and a width of 5 mm as indicated with 225 and 220 in the cross-section 215 of FIG. 2. Of course, other dimensions can be conceived that however must satisfy the criteria that they keep a cooking pot at a certain distance to optimally insulate it from the cooking surface 220 while at the same time allowing high frequency energy to be transmitted into e.g. the bottom of the cooking pot. Preferably, the material of the cooking hob is glass ceramics.

FIG. 3 shows another example of an embodiment of a cooking plate 100 according to the present invention. Here, the cooking plate 100 comprises spacers 310-370. At the left of the square shaped cooking areas shown in FIG. 3, the spacers 310-335 are oriented horizontally thereby allowing easy movement of cooking pots e.g. between cooking areas 385 and 380. On the other hand, on the right-hand part of FIG. 3, the spacers in form of bands 340-370 covering plural cooking areas 390 and 395 allow easy movement of cooking vessels in the vertical direction and also provide support for cooking vessels with a large bottom that extends e.g. over two cooking areas. In this manner, the invention can provide up to 4% energy savings as energy measurements show.

FIG. 4 shows a cooking vessel 400 having a bottom/spacer made of thermal insulating material in particular a material having a high thermal resistance to block energy flow from e.g. water boiled inside e.g. the kettle to the surface of an induction heater such as glass ceramic. The width of the bottom 410 is approximately 10 mm to provide optimum isolation while at the same time allowing full penetration of high frequency waves generated by the induction heater.

As FIG. 5 shows, the bottom/spacer of the vessel 400 shown in FIG. 4 may form different kinds of spacers having different shapes. As indicated with 515, a complete layer of insulating material covers the bottom. On the other hand, marked by 520, bands of insulating spacers are arranged in parallel along the total area of the bottom of the cooking vessel 400. The number and distance of these bands of isolating spacers is only for illustrative purposes and a suitable number may be chosen that provides support for the cooking vessel and secures a certain distance to the cooking surface of the induction hob. As shown at 530 in FIG. 5, the spacers may also take the shape of concentric circles, the number and distance of these circles is only chosen to illustrate the shape e.g. only one circle may also be sufficient to support a kettle for boiling water on a cooking surface of an induction hob.

### LIST OF REFERENCE NUMERALS

100,200: induction cooking plate
105, 210, 380, . . . , 395: induction cooking area
110, . . . , 120; 310, . . . , 370; 220; 410: thermally isolating spacers
125: curvature
220: height of curvature
215: cross-section through induction cooking plate
225: width of curvature
400: cooking vessel
410: isolating bottom/spacer of cooking vessel
515, . . . , 530: shape of spacers of bottom of cooking vessel

1. Induction cooking plate comprising:
an induction cooking area,
a thermal isolation at an exterior surface of the cooking plate.

2. Cooking plate according to claim 1, wherein the thermal isolation is implemented in a layer of a thermally isolating material embedded in a cooking surface.

3. Induction cooking plate according to claim 1 comprising a spacer.

4. Cooking plate according to claim 3 comprising plural individual spacers per cooking area.

5. Induction cooking plate according to claim 4, wherein the area covered by the spacers is small against the cooking area.

6. Induction cooking plate according to claim 3, wherein the spacer is built into the cooking area.

7. Induction cooking plate according to claim 6, where the spacer has the shape of a curvature around a cooking area.

8. Induction cooking plate according to claim 7, wherein the curvature has a height of 10 mm and a width of 4-6 mm.

9. Induction cooking plate according to claim 1 comprising plural cooking areas.

10. Induction cooking plate according to claim 9, wherein a spacer covers plural cooking areas.

11. Induction cooking plate according to claim 10, comprising a plurality of spacers provided in form of at least two bands.

12. Induction cooking plate according to claim 1, wherein the thermal isolation is provided in the form of thermal resistant material or glass ceramic.

13. Induction cooking vessel comprising a bottom/spacer of a thermal resistant material.

14. Induction cooking vessel according to claim 13, wherein the thermal resistant material is shaped as a disk or stripes or circles.

15. Induction cooking arrangement comprising a cooking area, a cooking vessel and a thermally resistant spacer between a cooking good and the cooking area.
